(19) United States
(12) Patent Application Publication
(10) Pub. No.: US 2016/0373866 A1
(43) Pub. Date: Dec. 22, 2016

(54) Light Flicker to Sound Conversion

(71) Applicant: Gordon Shaw Novak, West Lake Hills, TX (US)

(72) Inventor: Gordon Shaw Novak, West Lake Hills, TX (US)

(21) Appl. No.: 15/173,258

(22) Filed: Jun. 3, 2016

Related U.S. Application Data
(60) Provisional application No. 62/171,083, filed on Jun. 4, 2015.

(51) Int. Cl. H04R 23/00; H04N 5/235

(52) U.S. Cl. CPC H04R 23/008; H04N 5/2357

(57) ABSTRACT

Most electric light sources flicker, that is, the intensity of the light that is produced varies substantially in a periodically repeating pattern. In sensitive individuals, light flicker can cause headaches and other undesirable symptoms. However, humans cannot directly perceive that common light sources are flickering. This invention comprises a light sensor that measures light intensity, a means of signal processing that identifies and isolates the flicker component of the light, and an audio amplifier that amplifies the flicker component so that it can be converted to sound by a speaker or headphones. This makes it easy for ordinary people to identify and characterize flickering sources of light because they can directly perceive the flicker as sound.

This application is entitled to the benefit of Provisional Patent Application Ser. No. 62/171,083 filed Jun. 4, 2015.

### BACKGROUND

Technical Field

The present invention relates generally to test and measurement instrumentation and more particularly toward instrumentation to detect and characterize light source flicker. The present invention also relates generally to instrumentation to detect and characterize environmental conditions that might be unpleasant or hazardous to humans.

Background Art

Most electric light sources that are powered by alternating current (AC) electricity flicker, that is, the intensity of the light produced by the light source varies substantially and rapidly as a periodic function of time. Flickering light sources include fluorescent lights, compact fluorescents, light emitting diode (LED) lights powered by AC, television screens, and computer screens. Light dimmers that use pulse-width modulation (PWM) also introduce flicker: the apparent dimming of the light is caused by rapidly switching the electric power, and therefore the light, on and off.

Electric lights commonly flicker at twice the frequency of the electric power source [3] [1] [2], with a waveform that is approximately sinusoidal or similar to a full-wave rectified sinusoid. For 60 Hertz AC electricity, the primary flicker frequency of many light sources is 120 Hertz. Although 120 Hertz is above the so-called flicker fusion frequency of humans and is not consciously perceived as flickering, in sensitive individuals flickering light at this frequency can produce undesirable symptoms, including headache, fatigue, distraction, and reduced productivity [5] [6]. Individuals may not even realize that light flicker is the cause of their discomfort, since flicker is not directly perceived as such.

Flicker can be identified by constructing an appropriate electronic circuit with a high-speed light sensor and observing its output on an oscilloscope [3], but most people will not have the expertise nor resources to do this. There is therefore a need to be able easily and inexpensively to identify flicker sources and their magnitude and character.

Previous art has used modulated infrared emitters and infrared sensors to transmit information, as in a television remote control. Infrared emitters and sensors have also been used to transmit audio signals.

The present invention comprises a photodetector that senses the intensity of incident visible light, a means of signal processing to detect and separate the flicker component of the incident light, and amplification circuitry that converts the imperceptible flicker of light into easily perceptible sounds via a speaker or headphones.

One object of the present invention, therefore, is to provide an easily used, portable and inexpensive means of identifying lighting flicker.

Another object is to allow the user to identify sources of flicker so that the user can avoid those sources or replace them with light sources with minimal flicker.

Another object is to allow the user to identify flicker as a possible source of discomfort.

Another object is to allow consumers, architects, building managers, manufacturers, and sellers of lighting products easily to identify products that produce light flicker. This can allow products to be identified as flickering or having minimal flicker, so that buyers can select products with minimal flicker, and so that manufacturers and sellers can be motivated to produce and sell products with minimal flicker.

### DISCLOSURE OF INVENTION

A photodetector is employed that produces an output voltage that is proportional to the intensity of ambient visible light over a wide range of light intensities. It is necessary that the photodetector be able to respond to changes in light intensity several times faster than the highest flicker frequency to be detected.

The output of the photodetector is subjected to signal processing, such as bandpass filtering, to isolate the flicker component of the ambient light. The output of the signal processing module is the input to an audio amplifier that amplifies the flicker signal for presentation to the user as audible sound through a speaker or headphones.

### BRIEF DESCRIPTION OF THE DRAWINGS

FIG. 1 is a simplified block diagram showing circuitry for measuring light intensity, isolating the flicker component of the light, and amplifying the signal for presentation as sound through a speaker.

FIG. 2 is a more detailed circuit diagram of the block diagram of FIG. 1.

FIG. 4 is a photograph of a prototype implementation of the circuit of FIG. 2. The audio amplifier integrated circuit is at the center of the circuit board; the light sensor is the small clear plastic square with a lens dot in its center, to the left of the audio amplifier. The speaker is the black cylinder at the right.

FIG. 3 is a block diagram of an implementation of the invention using a small digital computer for signal processing.

FIG. 5 is a photograph of a prototype implementation of the block diagram of FIG. 3. The light sensor is mounted on the small circuit board at the left. The Teensy computer processor [4] board with orange light is at top center. The display at bottom center shows two waveform cycles and the computed flicker percentage, 26%; the flickering light source in this example is a Dell computer screen. The audio amplifier is at right, connected to a conventional speaker (not shown).

FIG. 6 shows an example of the flicker waveform produced by a compact fluorescent bulb as measured by an AMS-TAOS TSL251 light sensor, converted to digital values by an analog-to-digital (A/D) converter and stored in the memory of a computer processor as in the diagram of FIG. 3. This bulb has a flicker percentage of 9% and a fundamental flicker frequency of 120 Hertz.

### BEST MODE FOR CARRYING OUT THE INVENTION

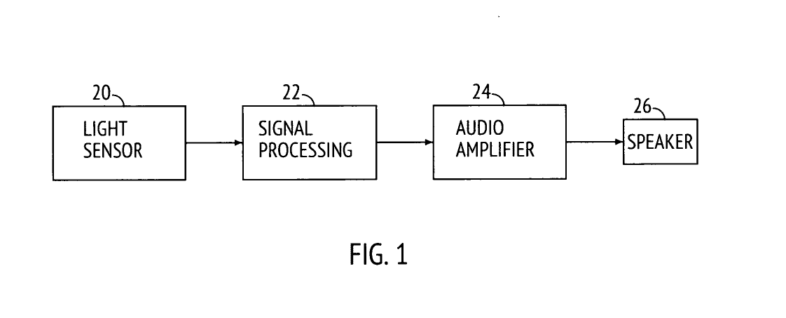

Referring to FIG. 1, the output of the Light Sensor 20 forms the input to a Signal Processing module 22 that enhances and isolates the flicker component of the incident light. The output of the Signal Processing module 22 forms the input to the Audio Amplifier module 24, which increases the electrical signal to be presented to the user as sound via a conventional Speaker 26 or headphones.

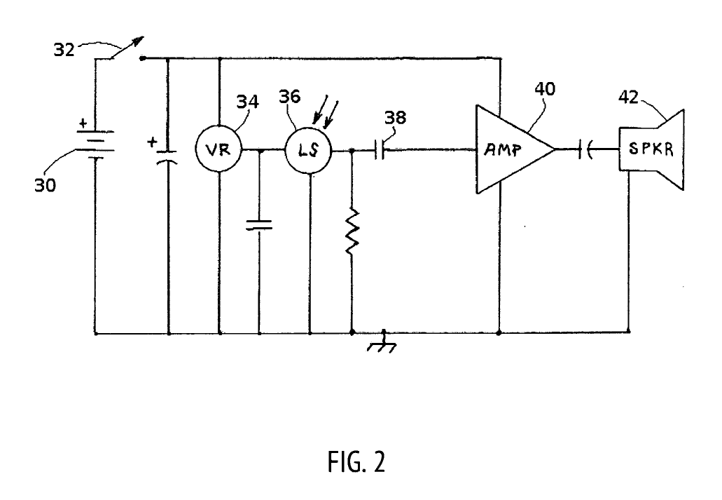

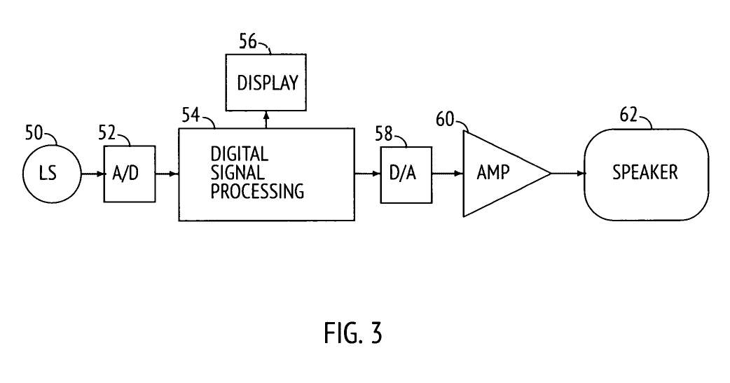

Referring now to FIG. 2, the circuit diagram of an embodiment of the invention is shown.

Components in the circuit of FIG. 2 are:

30 Battery

32 Switch

34 Voltage Regulator

36 Light Sensor, AMS-TAOS TSL251

38 Capacitor

40 Audio Amplifier, LM386

42 Speaker

Referring again to FIG. 2, the battery 30 and switch 32 provide power for the circuit. The voltage regulator 34 controls the battery voltage as required by the light sensor 36. The capacitor 38 couples the output of the light sensor 36 to the audio amplifier 40 and provides signal processing (high-pass filtering) to isolate the flicker component of the incident light. The audio amplifier 40 amplifies the signal to be presented to the user as sound via a speaker 42.

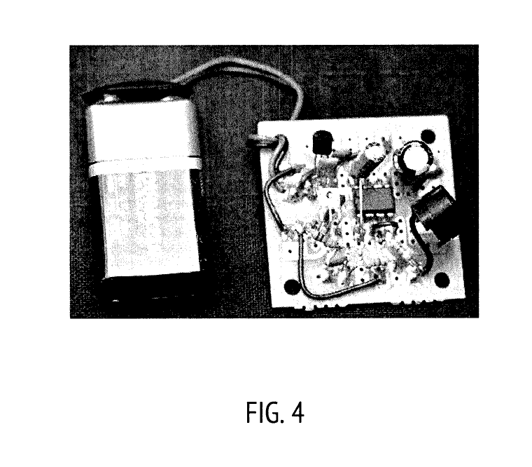

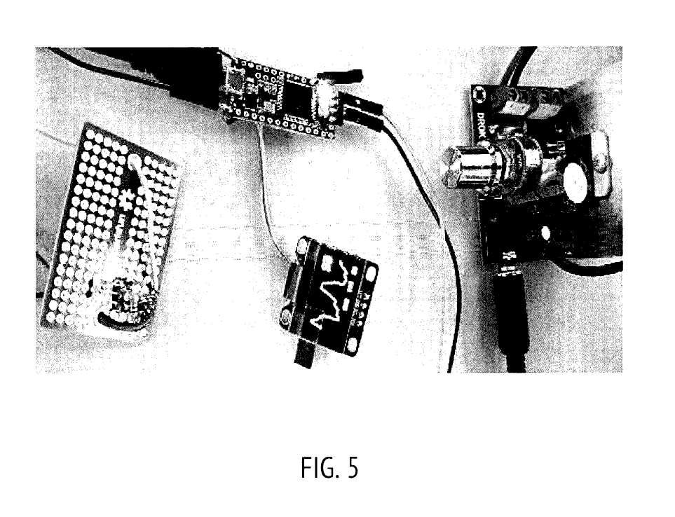

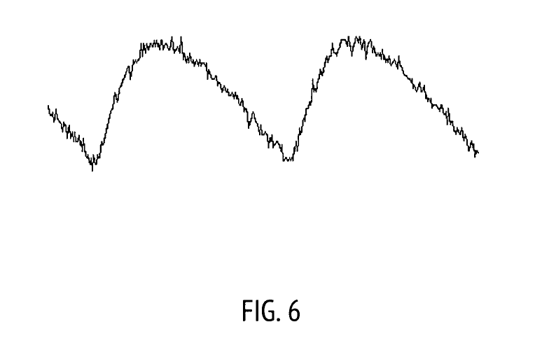

In the preferred embodiment of this invention, the wiring, circuitry, and battery used for the invention would be enclosed in a small plastic box. A photograph of an implementation of the circuit of FIG. 2 is shown in FIG. 4. This implementation is small, easily portable, and inexpensive.

The flicker to sound converter of the present invention has been implemented and tested. The invention makes it fast and easy for an ordinary person to identify and characterize various sources of light flicker, such as electric lighting, computer screens, and television screens.

A second method of embodiment of the invention is to use a small digital computer to perform signal processing. Although this embodiment is slightly more expensive, it produces more useful information via a display. Referring now to the block diagram of FIG. 3, the intensity of light is converted to a voltage by the light sensor 50; this voltage is converted to a digital value by the analog-to-digital converter 52 and is input to a small computer processor labeled 54. The computer software stores the waveform values in a circular buffer and computes an audio signal to be played by the speaker or headphones. The audio signal is converted back to an electrical voltage by the digital-to-analog converter 58; this signal is amplified by the audio amplifier 60 to be strong enough to be played through the Speaker 62. In addition, the computer can control a small attached Display 56 so that it displays the flicker waveform and computed values such as percent flicker [2].

A photograph of an implementation of the circuit of FIG. 3 is shown in FIG. 5. Referring now to FIG. 5, the light sensor is mounted on the small circuit board at the left of FIG. 5. The Teensy computer [4] processor board with orange light is at the top center of FIG. 5. The display at the bottom center of FIG. 5 shows two waveform cycles and the computed flicker percentage, 26%; the flickering light source used in FIG. 5 is a Dell computer screen (not shown). The audio amplifier is at the right of FIG. 5, connected to a conventional speaker (not shown).

Computer software code in the C++ language for the Teensy 3.1 processor [4] used in FIG. 5 is shown in Appendix A.

### REFERENCES

[1] Wanda Lau, “Fighting Flicker,” Architectural Lighting, http://www.archlighting.com/leds/leds-fighting-flicker_o.aspx

[2] Brad Lehman, A. Wilkins, S. Berman, M. Poplawski, and N. Miller, “Proposing measures of flicker in the low frequencies for lighting applications,” Energy Conversion Congress and Exposition (ECCE), 2011 IEEE, pp. 2865-2872.

[3] Michael Poplawski and Naomi J. Miller, “Exploring flicker in SolidState Lighting: What you might find, and how to deal with it,” Pacific Northwest National Laboratory, 2011. Available at bit.ly/1hgwlrH.

[4] www.pjrc.com/teensy

[5] A. J. Wilkins, I. NimmoSmith, A .T. Slater, and L. Beducs, “Fluorescent lighting, headaches and eyestrain,” Lighting Research and Technology, vol. 21, no. 1, p. 11, 1989.

[6] Frances Wilkinson, “Detection and discrimination of flicker contrast in migraine.” Cephalagia, Pubmed 21493642.

What is claimed is:

1. An electronic device having a light sensor capable of sensing visible light and having a fast response time, means of signal processing to identify and isolate the flicker component of the incident light, and means of amplification to present the flicker signal to the user as sound via a speaker or headphones.

2. The device of claim 1, where signal processing techniques are used to isolate, identify, process, store, or enhance the measured light intensity signal. These signal processing techniques may include any combination of low-pass filtering, high-pass filtering, band-pass filtering, Fourier spectral analysis, autocorrelation, time delays, feedback, or other advanced techniques. The signal processing may be performed by analog electronic circuitry, digital electronic circuitry, digital computer processing, or any combination of these.

3. The device of claim 1, where a computer processor is used to perform signal processing.

4. The device of claim 3, where a memory component is used to store a plurality of measured light intensity values.

5. The device of claim 1, where a volume control is provided to allow the user of the device to adjust the sound level.

6. The device of claim 1, where a meter or other display device is used to present characteristics of the flicker signal, such as its fundamental frequency, amplitude, flicker percentage, or other flicker characteristic measurements [?].

7. The device of claim 1, incorporating a display device to present a visual waveform of the flicker signal.

8. The device of claim 1, incorporating terminals to which an oscilloscope can be connected to display the flicker waveform.

9. The device of claim 1, using a digital camera as a light sensor and incorporating signal processing of the camera output to derive a representation of the flicker signal as sound.

10. The use of the techniques of the above claims to provide audible, visual, or other warnings of possibly harmful or distracting light sources, which might include lasers aimed at a driver, pilot, military soldier, or public safety officer.
